(19) United States
(12) Patent Application Publication
(10) Pub. No.: US 2015/0192089 A1
(43) Pub. Date: Jul. 9, 2015

(54) Piston pin unload for oil film renewal

(71) Applicant: Patrick Andrew Kosheleff, Yankee Hill, CA (US)

(72) Inventor: Patrick Andrew Kosheleff, Yankee Hill, CA (US)

(21) Appl. No.: 13/999,031

(22) Filed: Jan. 6, 2014

(51) Int. Cl. F02F 3/00; F01M 11/02

(52) U.S. Cl. CPC F02F 3/0069; F01M 11/02; F01M 2011/025

(57) ABSTRACT

In a reciprocating engine piston, added equipment to renew the piston pin's oil film once per crankshaft rotation. The equipment is located between the connecting rod's small end and the underside of the piston crown. There is a plunger carrier with a plunger, and a saddle with a plunger bore. The saddle closely straddles the plunger carrier, maintaining the alignment of the arcuate plunger with the arcuate plunger bore, for a plunger stroke without friction. The small end's natural oscillation during crankshaft rotation powers the plunger's working cycle. There is an oil-filling stroke and a delivery stroke. The delivery is to the saddle's top, which is just below the piston crown. The oil pressure pushes upward on the piston crown, lifting the piston slightly and the piston pin bosses off the piston pin. In the small gap thus created, new oil can enter, recreating the oil film.

### BACKGROUND OF THE INVENTION

U.S. Pat. No. 3,056,638 for a reciprocating engine creates a recurring small gap below the piston pin to renew the oil film. It discloses a piston-and-connecting rod assembly. The upper end (the “small end”) of the connecting rod is shaped not round but slightly eccentric to the axis of the piston pin. Once per crankshaft revolution, the eccentric meshes with a concave surface under the piston crown. This is caused by the natural oscillation of the connecting rod as its angularity changes continually during crankshaft rotation. The bulging portion of the eccentric acts as a cam when it passes under the concave surface, pushing up on it. The piston moves up slightly, as do the piston pin bosses. They pull the piston pin upward a little, creating increased clearance to the bushing in the rod small end. A renewal oil film can penetrate the increased clearance between the bottom of the pin and the bottom of the bushing. This restores the oil film between the piston pin and the bushing.

Our invention also unloads the piston pin, but the implementation is different. Hydraulic pressure is used to push upward on the bottom of the piston crown. The result is also different: The clearance obtained is between the piston pin and the piston pin bosses.

U.S. Pat. No. 3,027,207 will achieve the same result, but mechanically. The action is almost identical to that of U.S. Pat. No. 3,056,638 above. Clearance for a renewal oil film was not claimed, however, because his intent was direct bearing of the piston head on the connecting rod.

U.S. Pat. No. 3,200,798 for a variable compression ratio piston has an oil pumping action somewhat close to our own. A raised bump on the connecting rod small end pushes on a pump plunger. Pressurized oil is sent upward into a chamber under the moveable piston crown, causing it to lift. Quite similar to our mechanism. But his raised bump works as a cam, which is subject to wear. The push on our plunger is aligned with the back of the plunger.

In U.S. Pat. No. 2,066,489 the wear limitation is decreased by an arm pushing on the pump plunger. However, most of the contact includes sliding. An improvement is the arm shaped as a gear tooth. This has rolling contact at the pitch radius of mesh, a likely place for the point of highest load, therefore a good thing. But sliding wear remains at the other points.

### SUMMARY OF THE INVENTION

A reciprocating engine piston with added equipment above the connecting rod and below the piston crown. The ultimate goal of the invention is to renew the oil film at the top of the piston pin once per revolution of the crankshaft. The proximate goal is to lift the piston slightly, using oil at high pressure pushing up on the bottom of the piston crown. This will cause the piston pin bosses to lift off the piston pin, creating a small gap between them through which refill oil can enter.

In the embodiment, the new equipment includes:

1) a plunger carrier with an arcuate plunger, and
2) a fixed saddle with an arcuate plunger bore. The nomenclature:

The plunger carrier is a tall curved ridge, the plunger is a slender curved rib and the plunger bore is a curved channel in the saddle.

The plunger carrier is located atop the small end of the connecting rod and bears the smaller plunger above it. The plunger carrier oscillates back and forth in time with the small end. The saddle with two uprights straddles the plunger carrier. The saddle's plunger bore accommodates the working stroke of the plunger. There is a check valve upstream of the plunger bore. The plunger pumps oil.

In operation, the plunger reciprocates within the plunger bore once per revolution of the crankshaft. On the outstroke, the plunger draws in some engine oil admitted by the check valve, filling the plunger bore. On the in-stroke, the check valve closes and the plunger delivers the captive oil under high pressure to the saddle top below the underside of the piston crown. Check valve opening and closing are controlled by the reversing inertial forces generated by piston acceleration and deceleration during its travel.

The top of the saddle may include a shallow oil pan. The high-pressure oil pushes the piston crown upward slightly. The piston pin bosses are part of the piston structure, so they move up too. A small gap opens up between them and the piston pin, allowing oil to enter and renew the oil film.

The plunger and the plunger bore are circular arcs, for a mesh without friction. Close clearances between saddle and plunger carrier maintain plunger alignment. The saddle does not inhibit any motion of the plunger carrier in the sideways direction, in order to allow normal side play of the connecting rod.

The saddle's curved channel, which is the plunger bore, has a transverse cross-section resembling a square missing a side: Instead of a floor, the channel has a long opening. Refill oil is routed upwards to the plunger bore through the long opening. The circular top of the plunger carrier then functions as a moving floor, blocking by close clearance the leakage from the long opening.

### BRIEF DESCRIPTION OF THE VIEWS

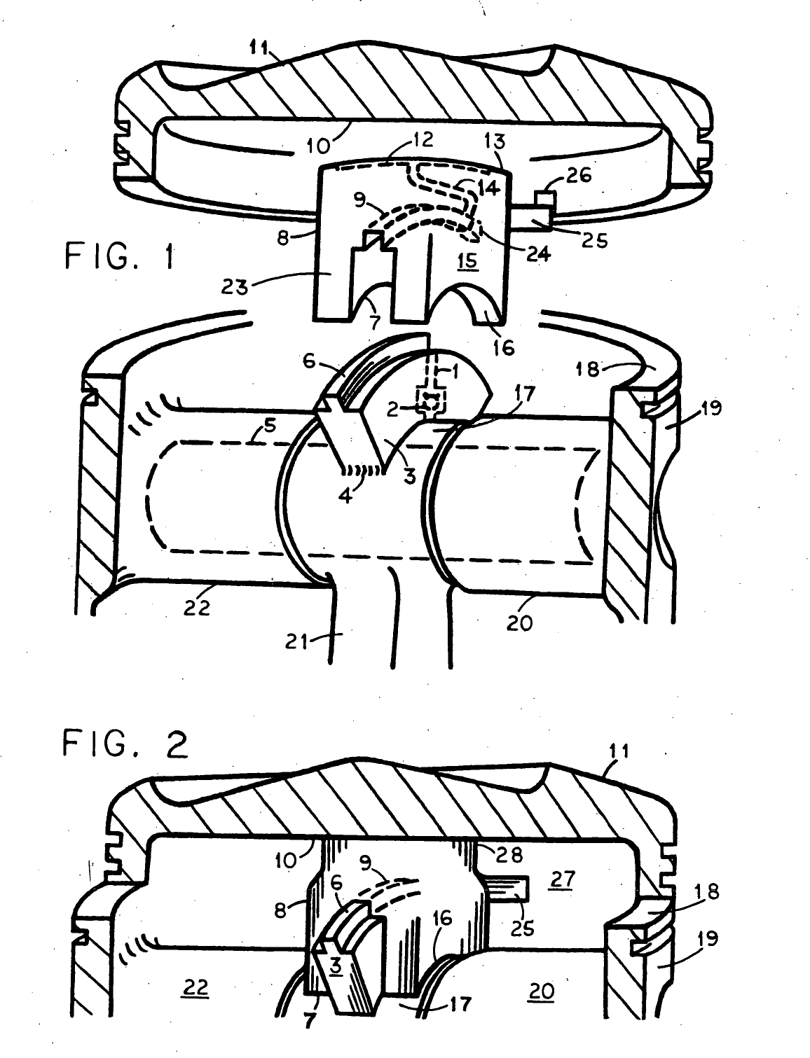

FIG. 1 is a cutaway and exploded elevation of an engine piston and connecting rod assembly plus the new parts.

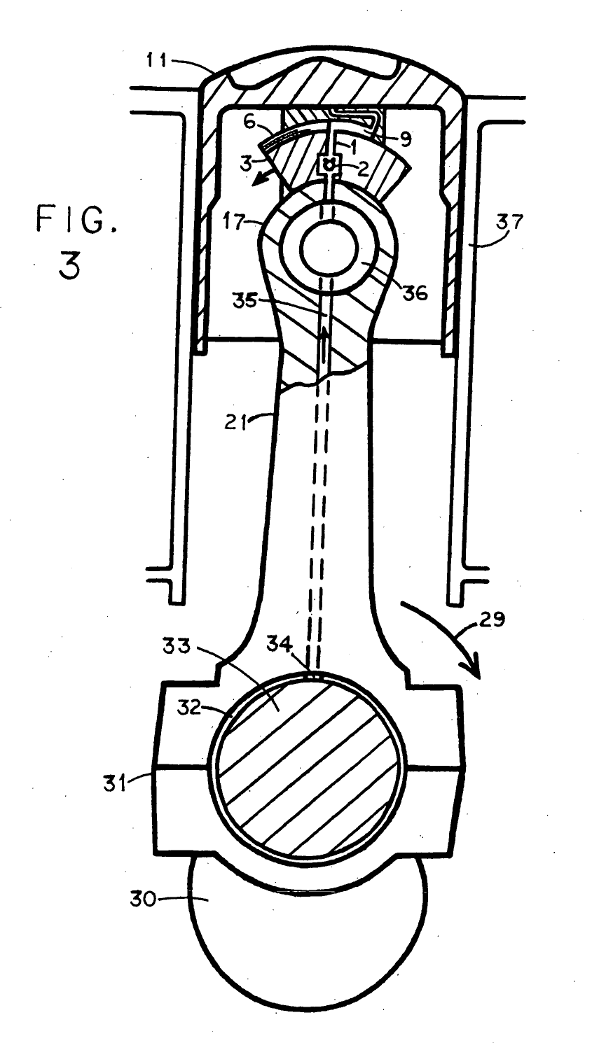

FIG. 2 is an elevation of the assembled new parts.

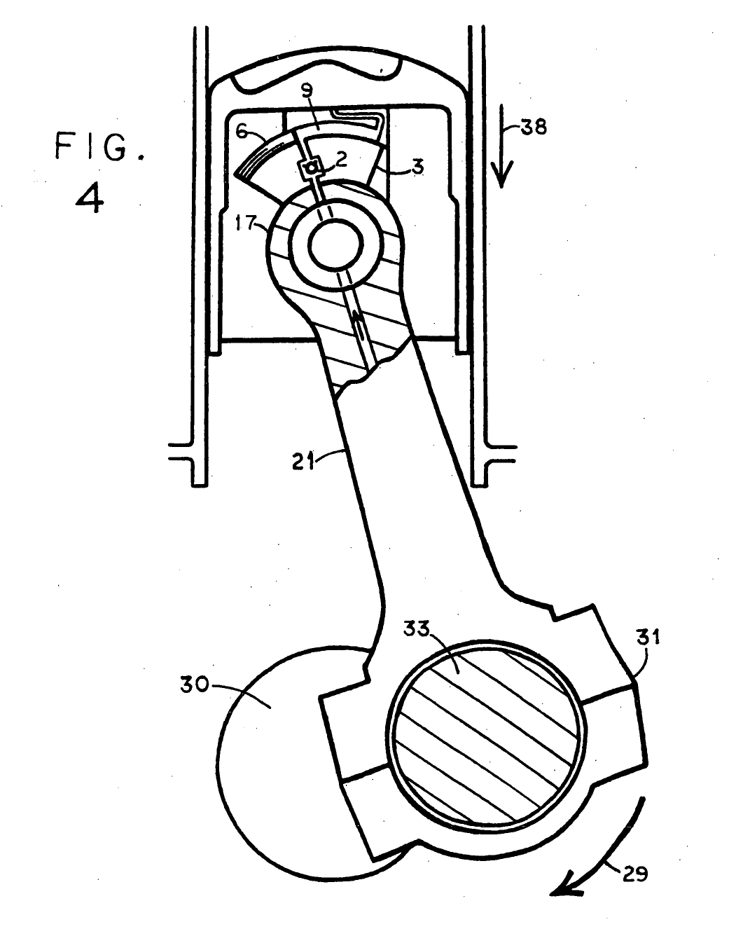

FIG. 3 is a partly sectional elevation of the new parts in action, with the engine components at Top Dead Center (“TDC”).

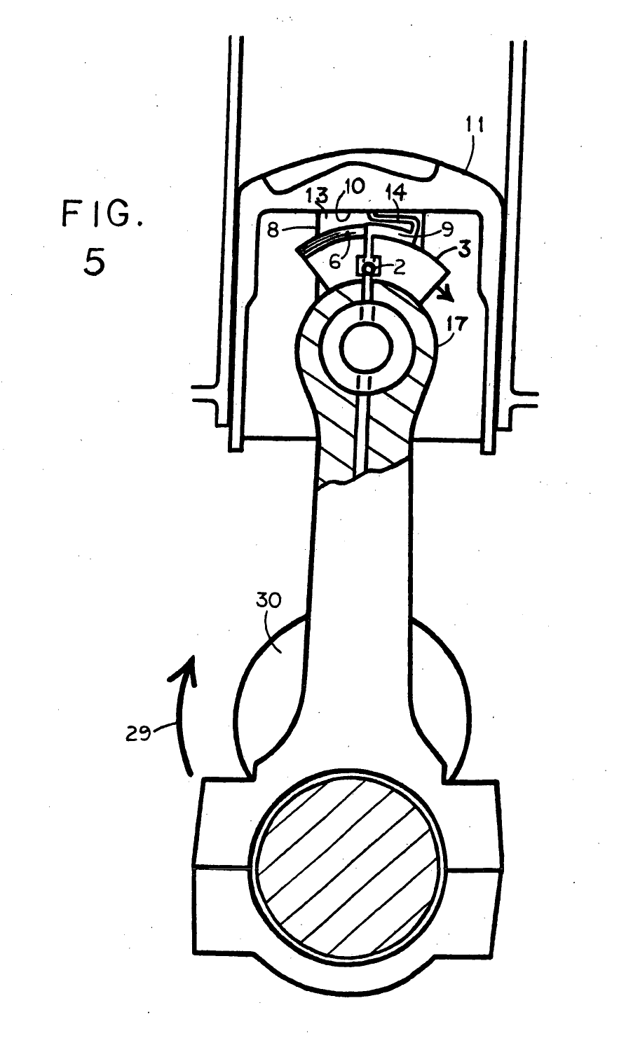

FIG. 4 is similar to FIG. 3 but at 80° after TDC.

FIG. 5 is similar to FIG. 3 but at 180° after TDC.

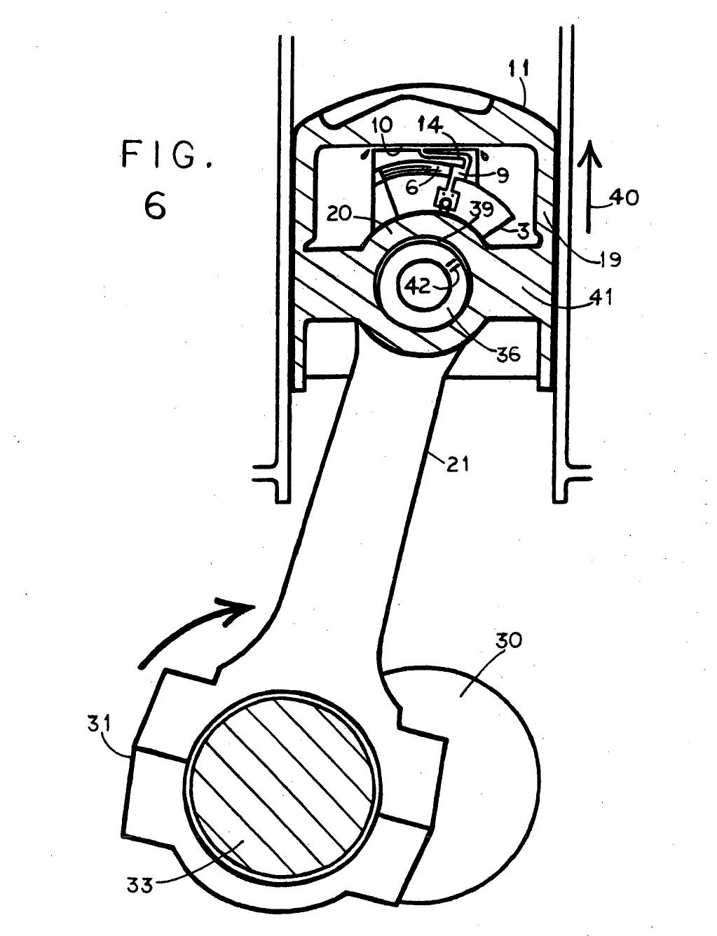

FIG. 6 is similar to FIG. 3 but at 270° after TDC.

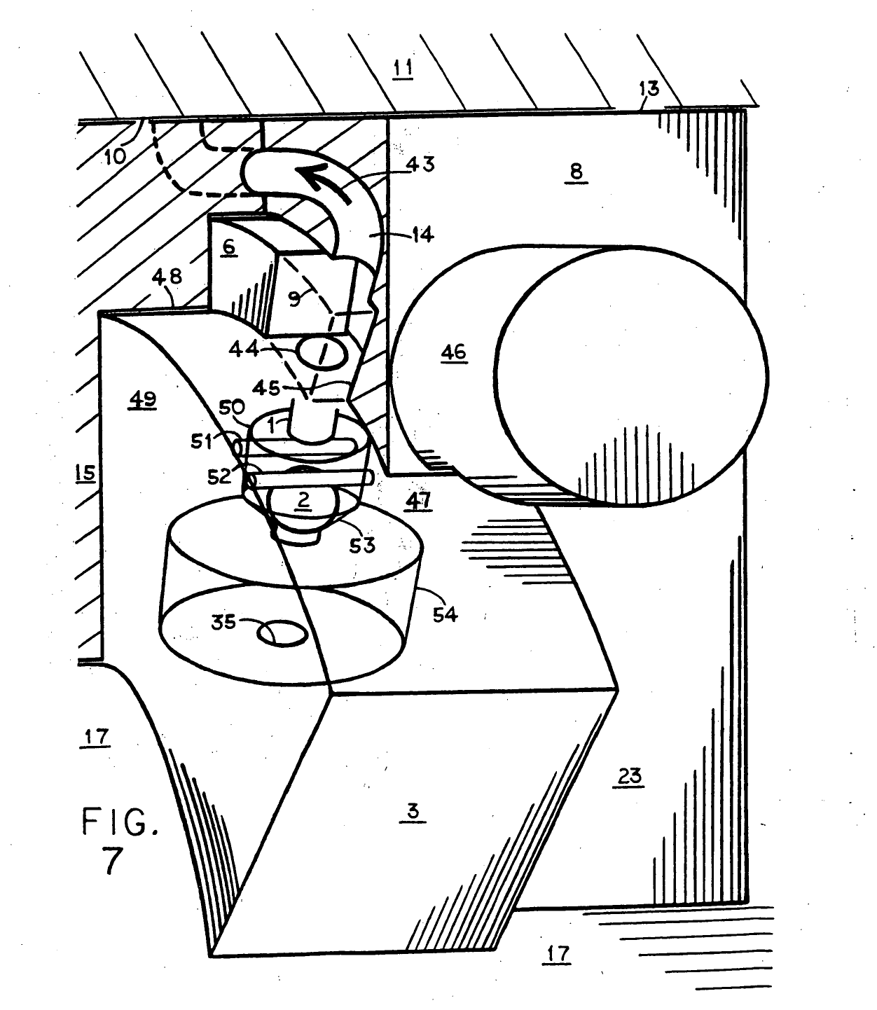

FIG. 7 is a partial cutaway elevation of the back of the saddle.

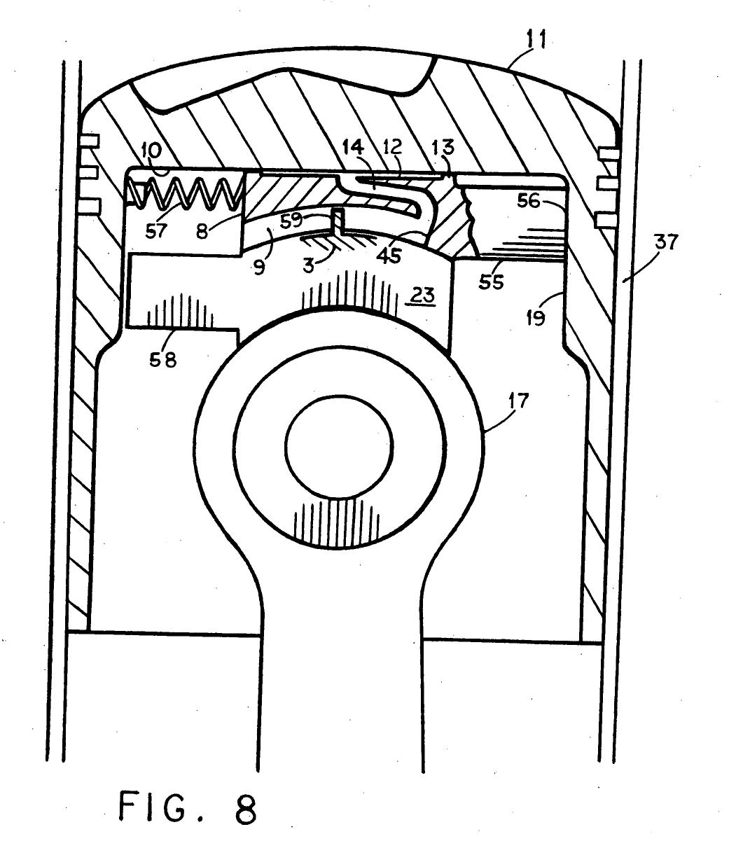

FIG. 8 is a sectional elevation of the saddle for heat transfer.

### DETAILED DESCRIPTION

FIG. 1 starts with a cutaway view of an engine piston 11, 19. The piston has been sliced into two pieces at parting line 18, mainly to expose the underside of piston crown 11. Piston skirt 19 has been sawed vertically, and the near half removed, to show piston pin bosses 20, 22 and the top 17 of connecting rod 21. The piston itself is almost unchanged from conventional ones, the only difference being flat underside 10 in piston crown 11. Underside 10 will closely approach top deck 13 of saddle 8, one of the new parts. The other new part is plunger 6, which will stroke back and forth in channel 9. Channel 9 is the plunger bore 9. Plunger carrier 3 positions plunger 6 correctly and transmits to it small end 17's oscillation.

Some background on reciprocating engines follows. Piston pin 5 is usually coated with a thin “squeeze film” of lubricating oil between it and piston pin bosses such as 22. In operation, the oil film compresses under load, protecting the parts. The invention aims to assist the periodic renewal of the oil film. This is especially useful in 2-stroke cycle engines with a high degree of boost. The working gas pressure on piston crown 11 never relaxes completely, eventually pushing the oil film out of existence. High wear is the result. The invention will physically lift piston pin bosses 20, 22 very slightly off the piston pin, allowing oil to enter the gap.

Some equipment to do that is seen in FIG. 1 as a plunger 6 which sweeps a plunger bore 9 of the same arcuate shape. Sweeping is preferably done with close clearance between plunger 6 and plunger bore 9, without friction. Plunger 6 will deliver oil under high pressure to saddle top deck 13. Saddle 8 doesn't move; its feet 7, 16 will rest on small end 17 (FIG. 2.) In FIG. 2 piston crown 11 will rise a little instead. Piston pin bosses 20, 22 will move up too, attaining the proximate goal of the invention. To be seen in FIGS. 3-6.

In FIG. 1, saddle 8 is strong because it is one-piece. Plunger bore 9 and the large space below it can be made in one pass of a cutter wheel (not shown.) To finish that plunger bore 9, an arcuate plug at location 24 is fastened at the end of the cut for bore 9 in order to seal it there. Bore 9 is then able to become a chamber. Alternatively, if a slot cutter mills out the plunger bore, then an end plug at 24 can be just saddle material left in place. It seems to be a stronger solution, e.g., wall piece 45, to be seen in FIG. 7.

Besides saddle 8, the new parts are actually a ridge 3, a rib 6 and a channel 9. To achieve a descriptive text, curved rib 6, tall ridge 3 and channel 9 are set aside, in favor of the words, “plunger 6, plunger carrier 3 and plunger bore 9” respectively. The latter set of three terms is more suggestive of the operation of the new parts as a pump.

Attention turns to the mechanics of the new equipment. The most important consideration is the motion of the parts. Plunger carrier 3 sits on top of small end 17. Carrier 3 is preferably unitary with small end 17, or made solid by, e.g., weld 4. Thus, plunger carrier 3 shares the ongoing oscillation of small end 17 during crankshaft rotation. The rhythmic motion of plunger 6 back and forth in plunger bore 9 is the pumping action which makes the invention work.

Oil feed to plunger bore 9 is by duct 1 connected to the engine's oil supply (to be seen in FIG. 3.) Oil flow to duct 1 is under control of ball 2 in a check valve whose operation depends on the inertial forces generated by the piston's reciprocating motion. To be seen in connection with FIGS. 3-6.

FIG. 2 shows piston 11, 19 whole again. Plunger 6 is in mesh with plunger bore 9 and ready for operation.

Saddle 8 of FIGS. 1 and 2 moves very little. Uprights 15 and 23 have circular bearing surfaces at bottoms 7 and 16. They sit on oscillating top 17 of rod 21 as it rocks underneath. Thus, rod top 17 must be machined round accurately. Rod top 17 is smooth on both sides of plunger carrier 3, being journals for saddle bottoms 7 and 16.

FIG. 3 includes the piston, connecting rod and crankshaft assembly. Piston 11 is at Top Dead Center (“TDC”) in cylinder 37. Conventionally, this is at zero degrees of rotation of crankshaft main bearing journal 30. The big end 31 of connecting rod 21 is riding around rod bearing journal 33 (crankpin 33.) A known feature as drilled hole 34 admits part of the lubricating oil which was ducted to rod bearing 32 through the usual drilled holes (not shown) in the crankshaft. The oil, under pressure from the engine's oil pump, rises past drill hole 34 and up vertical duct 35; this duplicates FIG. 9 of SAE Paper 660344. The oil crosses drilled piston pin 36 and enters the check valve cavity containing ball 2.

As piston 11 rides up and down cylinder 37, its displacement versus time approximates ideal Simple Harmonic Motion. In this well-known trajectory, a repeating sine curve, the piston speed goes to zero for an instant at TDC, but the acceleration is greatest. That's because the motion is being reversed. In consequence, small ball 2 of the check valve hangs high, off its seat. The open valve lets the oil continue onward. It flows around ball 2 then through hollow duct 1. Connecting rod 21 pivot is piston pin 36. With crankpin 33 rotating to the right (arrow 29), small end 17 is turning counterclockwise, taking plunger 6 and plunger carrier 3 with it (small arrow.) Plunger 6 is leaving plunger bore 9, creating new volume behind the plunger. The oil keeps going and fills that volume too. This is the refill portion of the plunger cycle.

FIG. 4 shows rod journal 33 at 800 of rotation past TDC. Rod big end 31 is on one side of crankpin 33's circular orbit. Piston displacement versus time is only approximately Simple Harmonic Motion, because of connecting rod angularity. Piston speed 38 is very high, and acceleration is near zero. For an instant, the piston is coasting at high speed (arrow 38.) Small ball 2 of the check valve has no cause to move from its high perch yet, although that will soon change. But for now, plunger 6 has retracted the maximum out of plunger bore 9. Oil has filled plunger bore 9. This ends the refill duration.

FIG. 5 shows the piston at Bottom Dead Center, 180 degrees of crankshaft journal 30 rotation beyond TDC. In the reverse of FIG. 3, in FIG. 5, small end 17 is now turning clockwise, taking plunger carrier 3 to the right (small arrow.) The volume of plunger bore 9 decreases. The oil cannot flow backward because check valve ball 2 has dropped to its seat. This is because of the deceleration of the piston. Referring to Simple Harmonic Motion again, the piston is momentarily stopped, but the downward acceleration is greatest (motion reversal.) Oil pressure also keeps ball 2 on its seat.

With backflow blocked, the captive oil in plunger bore 9 flows up duct 14 and is delivered to the flat underside 10 of piston crown 11. At the moment there is no space visible yet between flat underside 10 and top deck 13. Oil pressure pushes equally on floor 10 and top deck 13. Saddle 8 can't move downward, so piston crown 11 moves upward very slightly instead. (It is noted that plunger 6 may have been sized much larger, for visibility's sake, than it needs to be to pump enough oil to move piston crown 11 incrementally. In any case, a small movement is the proximate goal of the invention.) FIG. 5 shows the middle of the working stroke of plunger 6.

FIG. 6 shows the parts at 3/4 of one complete revolution of crankshaft journal 30: 270° beyond TDC. Connecting rod big end 31 is on the other side of crankpin 33's circular orbit. Piston 11 “coasts” (arrow 40) at high speed. An important visual change is that ring-shaped item 20 is a piston pin boss, not part of connecting rod 21. Plunger carrier 3 is at the end of its turn to the right. Plunger 6 is similarly at the end of its stroke. The oil, formerly in plunger bore 9 in FIG. 4, has now been pushed out, upward through duct 14 and against underside 10. Completing the action of FIG. 5, steady push on floor 10 has moved piston crown 11 upward visibly now (some 0.002″ in reality.) Piston pin boss 20 is an integral part of the piston and moved up slightly too. A small gap 39 (again 0.002″) appears between piston pin boss 20 and the top of piston pin 36. This is the goal of the invention. The oil film between piston pin boss 20 and piston pin 36 can renew itself through gap 39.

Capillary action on the usual oil mist rising from the crankcase is the most common way to renew this oil film. But pressure feed is also possible, using small hole 42 drilled in piston pin 36. Two small holes 42 actually, one for each piston pin boss 20,22 (FIG. 1.) Recall that the interior of piston pin 36 must already be under pressure in order to convey upward the oil in oil duct 35 of FIG. 3.

In FIG. 6, web 41 is meant to suggest the unitary relation of piston pin boss 20 to piston skirt 19. Then when piston crown 11 moves up its 0.002″ or so, piston pin boss 20 moves up too.

It should be noted that the gas loads are already of some magnitude in FIG. 6, where compression of the charge on the up-stroke of the piston has already started. Therefore, the oil pressure under floor 10 may have to be quite high to move the piston opposed by the gas load on piston crown 11. Two things can now be observed.

First, the gas load of compression may be so large at the point of FIG. 6 that the oil film was actually rebuilt in FIG. 5, not FIG. 6. This is easily achieved. FIG. 5 is where the gas load is the smallest. That's because the gas load is only the boost pressure, not the compression pressure. Thus, gap 39 from FIG. 6 may quite reasonably appear in FIG. 5 instead. The timing of events shown in FIGS. 5 and 6 should not be interpreted too literally. Oil-filled gap 39 seen in FIG. 6 may in fact be squeezing down from compression gas load by the time of FIG. 6. It will not matter. Squeeze film action on a piston pin is a well-tested phenomenon.

Secondly, the pumped oil could reach very high pressure, but can't be allowed to break something. A possible solution is to add a conventional spring-loaded pressure relief valve. (not shown). There are big reaction forces on saddle 8. In FIGS. 5 and 6, plunger 6 is pumping oil out of plunger bore 9 against great resistance from oil pressure. There will be a strong push on saddle 8 toward the right. Returning to FIG. 1, that load is easily handled by strut 25 which will reach across to rest against contact patch 26. FIG. 2 shows the assembled piston, in which the end of strut 25 covers the contact patch as strut 25 reaches the inside wall 27 of the piston skirt. That absorbs directly the oil pressure push to the right on saddle 8. This desired result depends on strut 25 making constant contact with patch 26 without interfering with the slight upward motion (about 0.002″) of the piston when gap 39 seen in FIG. 6 is being created. With lubrication from the usual oil mist, it seems doable.

We examine the effect of connecting rod angularity on check valve timing. A connecting rod can be replaced by a Scotch yoke, which has no angularity. (In the Patent literature, Scotch yokes can be found in Bourke patents.) With a Scotch yoke, the piston has true Simple Harmonic Motion. That is, a graph of piston position in the cylinder versus crankshaft rotation angle is a perfect Sine curve. The top half of the sine curve spans the duration of time when the inertial force on the piston is upward. The bottom half of the sine curve is when the inertial force is downward.

We used inertial force periods to lift the check valve ball off its seat, then put it back on its seat. The timing of these events coordinates well with the out-stroke and in-stroke of plunger 6. The rocking of the plunger is due to the changing angle of connecting rod 21. That convenience wouldn't be there with a Scotch yoke. But the angularity of the connecting rod changes the timing of events. The Sine curve is distorted: The top half gets narrower and the bottom half gets wider.

With the Scotch yoke, upward inertial force on the piston lasts from 270° before TDC until 90° after TDC. A nice, even interval spanning exactly half of a 360° orbit of crankpin rotation. But with a connecting rod 21, upward inertial force ends around 80° after TDC (our FIG. 4.) A similar narrowing duration exists on the other side of connecting rod 21's swing. Thus, the time for oil refill will be some 2×80°=160°, and the time for pumping will be 360°−160°=200°. A significant but not fatal difference from Simple Harmonic Motion. However, these intervals change if the connecting rod length is different from our own.

Specifying the exact inertial period durations in the Claims would require burdensome detail. Duration of upward inertial force for the refill process will simply be understood to be only part of the top half of rotation of the crankshaft.

FIG. 7 is the view from the back of the saddle, and plunger carrier 3 in the position shown in FIG. 6. In the greatly enlarged view in FIG. 7, saddle 8 straddles plunger carrier 3, with upright 23 resting on connecting rod small end 17. Half of other upright 15 has been removed for this part-sectional view showing possible variant plunger 6 at the end of its travel. Short plunger 6, has swept most of the volume of plunger bore 9 depicted here as dashed lines. Oil 43 formerly in plunger bore 9 flows through duct 14 to the flat underside 10 of piston crown 11. There the high oil pressure will lift piston crown 11 slightly, as seen in FIG. 6. Shallow pan 12 carved out of top deck 13 in FIGS. 1 (and 8) may be more practical than a flat top deck because the upward push may be sustained over a greater area.

In FIG. 7, the oil which filled plunger bore 9 initially emerged from oil hole 44, which is the top of oil duct 1 also identified in FIGS. 1 and 3.

In FIG. 7, an important feature is top surface 47 of plunger carrier 3. During the normal oscillation of small end 17, plunger carrier 3 rocks back and forth under plunger bore 9. Top surface 47 slides one way then the other directly under the bottom of plunger bore 9. At this point it makes sense to consider plunger bore 9 as a channel 9 because it has no floor of its own. A transverse cross-section of channel 9 would be a square missing one of its four sides, the one at the bottom. Channel 9 has a slot there instead of a floor, as seen in FIG. 1. Huge leakage through the slot is prevented in FIG. 7 by top surface 47 which blocks the slot and is a moving floor for channel 9. Of course, channel 9 may have a cross-section different from square. In another variation plunger 6 can be just a short block 6 (FIG. 7) rather than the long rib in FIG. 1; or even just a tab 59 (FIG. 8.)

In FIG. 7, strut 46 absorbs the push from oil pressure on channel end wall 45. Strut 46 would transmit the push to the piston skirt like parts 25 and 27 in FIG. 2.

Saddle 8 in reality would be about two inches high, not the size seen in FIG. 7 except in large engines.

Some parts in the interior of plunger carrier 3 are seen in FIG. 7. The parts are drawn as if plunger carrier 3 was transparent, as with the parts themselves. The outlines are what matters. Item 50 is the check valve “body”, even though it's actually a hollow cylinder full of oil and containing check valve ball 2. Ball 2 is on its seat, held there at this time mainly by the high oil pressure from the end of plunger 6's in-sweep of plunger bore 9. A conical funnel at 53 helped ball 2 find its seat inertially earlier in case check valve body 50 happened to be at an angle to the vertical.

At other times, oil will flow upward through oil hole 44 during the refill event. Ball 2 would come off its seat and move upward to rest against the two short rods 51 and 52. Short rods 51, 52 are thin enough to not impede oil flow, but they will stop ball 2 and keep it from blocking oil duct 1.

An improvement to the refill process is ready chamber 54 just upstream of check valve body 50. Ready-chamber 54 has the time to fill up with oil from below during plunger 6's working stroke (the in-sweep of plunger bore 9.) Then the oil doesn't have far to travel to fill up plunger bore 9 during refill. This decreases a possible delay caused by inertia of FIG. 3's oil column 35 as the oil starts to move upward once per revolution of the crankshaft. Ready chamber 54 makes it possible for the oil to flow all the time up oil column 35 of FIG. 3. It may avoid oil feed problems by ending interruptions.

An alteration was made to flat top deck 13 of FIG. 7. A new top deck is in FIGS. 1 and 8. Shallow pan 12 is carved out of the top of saddle 8. That leaves the narrow raised rim 13 which makes a complete circle around shallow pan 12. Rim 13 is what comes close to the flat surface of underside 10. Duct 14 which lets the oil under high pressure out of plunger bore 9 discharges the oil at the center of shallow pan 12. Then the oil will flow outwardly and, it is hoped evenly, in all radial directions toward new top deck 13 where it will leak out slowly. The continuous radial outflow of oil in all directions of the compass suggests that no oil will linger very long in shallow pan 12. Therefore, the oil should avoid being cooked by prolonged exposure to the temperature of piston crown 11.

In FIG. 7, plunger carrier 3 will be closely flanked by the two uprights 15 and 23 of saddle 8. Thus, when plunger carrier 3 moves left or right as a result of the connecting rod's side play, saddle 8 will move the same amount. This helps keep plunger 6 centered in plunger bore 9. Plunger 6 itself can be integral with plunger carrier 3, or just fastened to it. The downside of FIG. 7 is that saddle 8 represents a sizeable mass to move left or right during small end 17's side play. Therefore, the necessity of a high plunger carrier 3 so that tall side face 49 can push effectively on upright 15. With a uniform push on over half the height of saddle 8, there's a good chance saddle 8 will move left or right smoothly without scraping or tipping on piston crown underside 10.

In FIG. 7, the three walls of square cross-section channel 9, plus top surface 47 making the fourth wall, make up a working chamber. The whole plunger-swept volume is still contained in channel 9, which saves the characterization of saddle 8 as containing the plunger bore.

The planned small clearance between top surface 47 and a ceiling 48 of the large space between uprights 15 and 23 allows some small leakage. This will lubricate the moving parts, for instance carrier side wall 49 sliding past the inside wall of upright 15.

The floor missing from plunger bore 9 will cause an upward push on the ceiling of plunger bore 9 from hydraulic pressure. However, the area of shallow pan 12 (FIGS. 1 and 8) is much greater than the area of plunger bore 9's ceiling. There will be a net downward push on saddle 8 which keeps it firmly planted on small end 17.

FIG. 8 shows saddle 8 in vertical cross-section through channel 9. The plunger carrier has been removed from small end 17 to reveal the saddle interior. One upright is also omitted, leaving the inside wall of upright 23 visible. As in FIG. 7, end wall 45 of plunger bore 9 takes the push to the right from high oil pressure when the plunger is on the in-sweep. As before, the push to the right is absorbed by a strut, 55 in FIG. 8, which transmits the push to piston skirt 19; in order to keep saddle 8 from leaning right and skewing with respect to underside 10.

Strut 55 is expected to perform another function, heat transfer from saddle 8 to piston skirt 19 when the engine is shut down. This is to prevent possible cracking of some part when piston 11, 19 cools down by conduction to cylinder wall 37 faster than does the more enclosed saddle 8. Thus, strut 55 must make good contact to piston skirt 19 at area 56. Spring 57 delivering a mild but continuous push to the right can achieve that.

The weight of strut 55 could cause saddle 8 to experience unbalanced inertial forces causing tilting. Secondary strut 58 counteracts that by supplying a balancing weight. Strut 58 can be one of two issuing from the narrow uprights, to add up to sufficient weight.

Oil duct 35 in FIG. 3 could be a tube (not shown) on the outside of connecting rod 21, to preserve the rod's beam strength.

Highly-boosted four-stroke cycle engines weren't mentioned, but they are not excluded from the invention.

FIG. 2 shows a variation of saddle 8. Top deck 28 is narrower than top deck 13 in FIG. 1. In FIG. 2, top deck 28 is the width of the open space between piston pin bosses 20 and 22 if connecting rod small end 17 is not there. The open space is the room needed for a fly cutter (not shown) to pass upward in order to machine a circular spot very flat in underside 10. Then the parts are assembled. The tiny clearance desired between underside 10 and circular top deck 28 could then be accurate.

Throughout the text, the term, “rib” was set aside in favor of the more suggestive “plunger”, even though rib 6 doesn't look like a piston in typical plunger pumps. But for the Claims, nomenclature reverts to the physical parts, instead of the more operative terms used up to now. Thus,
“plunger” is replaced by “rib”;
“plunger carrier” is replaced by “ridge”,
and “plunger bore” becomes “channel”.

The “rib” 6 can be proportioned long enough, as seen in FIG. 1, to resemble a human rib; or it can be a shorter block 6 seen in FIG. 7; or it can be so short that it resembles a tab, as tab 59 seen in FIG. 8. The main advantage of long rib 6 in FIG. 1 may be less oil leak past the rib, because of the longer distance of close clearance to the channel 9 walls the leakage oil would have to travel. The main advantage of very short tab 59 in FIG. 8 would be less sliding friction.

The scope of the invention is found in the appended Claims.

1. In a reciprocating piston engine which includes a cylinder, a piston, a connecting rod and a crankshaft, added parts which will cooperate with said connecting rod and said piston to produce a new result; describing first the conventional portion of said engine:
a piston pin located in said piston; said piston incorporating two piston pin bosses with holes to house the ends of said piston pin; said connecting rod having a small end at said pin and a big end oppositely; said small end installed between said piston pin bosses and holding the middle of said piston pin, completing the connection of said connecting rod to said piston; said crankshaft having a crankpin; said big end riding on said crankpin, making the connection of said connecting rod to said crankshaft; said crankshaft having rotation; and said connecting rod converting said rotation to said piston's translatory motion within said cylinder in a known manner;
said piston pin capable of turning in either direction within said piston pin bosses; said turning providing a pivot for said connecting rod at said small end; during said rotation, said crankpin having a circular orbit; said big end also travelling in said orbit causing said connecting rod to have a swing from one side of said orbit to the other and back again; said swing continuing until said engine stops; said swing causing the usual oscillation of said small end;
said added parts comprising a rib, a ridge and a saddle; said piston having a piston crown spaced above said piston pin bosses;
said saddle located between said piston crown and said small end of said connecting rod; said piston crown having an underside;
said saddle having a top deck; said top deck located adjacent to said underside; the lower part of said saddle being two uprights with a space between them; said uprights having bottoms shaped as concave circular arcs; two convex circular arcs shaped in the top of said small end;
said rib being smaller than said ridge; said rib located atop said ridge; said ridge located atop said small end; said ridge narrower than said small end; said ridge located between said convex circular arcs; said saddle straddling said ridge; each said bottom contacting a said convex circular arc;
said small end performing its said oscillation under said bottoms; said ridge rocking back and forth within said space in time with said small end's said oscillation;
a channel formed in said saddle; said channel being curved; said channel located just above said space; said ridge being slightly narrower than said space between said uprights; said ridge being almost as high as the height of said uprights; said channel having substantially no floor of its own; said channel when originally made being open along its length to said space between said uprights;
the top surface of said ridge being curved and extending forward far beyond said rib; the curvature of said top surface being similar to the curvature of said channel; said top surface substituting with close clearance for the absent said floor of said channel;
said rib being about as high as said channel is deep, and almost as wide as said channel is wide; said rib located in said channel; said rib being adapted to sweep said channel with close clearances; said sweep reversing periodically by reason of said rocking back and forth of said ridge; said channel having an end plug, making a chamber with said rib at the other end;
engine oil constituting working fluid for said chamber; said oil flowing intermittently toward said chamber under control of an upstream check valve; said check valve being in communication with a supply of said engine oil;
said rib when on an out-sweep of said chamber allowing intake of said oil while said check valve is held open by upward inertial force during the top half of said rotation of said crankshaft; said inertial force reversing upon continued said rotation of said crankshaft; said check valve closing about the time said inertial force reverses; then said rib during an in-sweep pumping said oil to some higher pressure while closed said check valve experiences downward inertial force during the bottom half of rotation of said crankshaft; said oil at said higher pressure delivered to said top deck of said saddle;
said top deck having close clearance to said underside of said piston crown; and said oil under said higher pressure pushing up on said underside; said pushing up lifting said piston crown, which lifts said piston pin bosses slightly off said piston pin; thereby creating small gaps between said piston pin and said piston pin bosses for renewal oil to enter;
and the two previous paragraphs executing once for each revolution of said crankshaft.

2. The assembly of claim 1, further comprising a shallow pan in said top deck; said shallow pan almost spanning said top deck; a low raised rim substantially continuous around the periphery of said shallow pan; said rim being the portion of said top deck having said close clearance to said underside of said piston crown.

3. The assembly of claim 1, further comprising a ready chamber; said ready chamber located just upstream of said check valve; said ready chamber connected to said supply of said engine oil; said ready chamber experiencing a fill with said engine oil even when said check valve is closed; and said ready chamber releasing said fill to said check valve when said check valve is open.

4. The assembly of claim 1, further comprising a strut extending horizontally from the back of said saddle; said piston including a piston skirt; said piston skirt extending downward starting from said piston crown; and said strut reaching said piston skirt, in order to absorb thrust on said end plug caused by said engine oil resisting said pumping to said higher pressure.

5. The assembly of claim 4, further comprising a spring; said spring located just below said underside and substantially horizontal with respect to said underside; said spring pushing on a wall of said saddle; said wall being on the side of said saddle opposite that of said strut; and said pushing promoting prolonged contact of said strut with said piston skirt, to enhance heat transfer at said contact.

6. The assembly of claim 1, further comprising a short block replacing said rib.

7. The assembly of claim 1, further comprising a tab replacing said rib.
